(19) United States
(12) Patent Application Publication
(10) Pub. No.: US 2026/0276394 A1
(43) Pub. Date: Sep. 17, 2026

(54) INFORMATION PROCESSING APPARATUS, INFORMATION PROCESSING METHOD, AND NON-TRANSITORY COMPUTER-READABLE MEDIUM

(71) Applicant: NEC Corporation, Tokyo (JP)

(72) Inventors: Norihito OI, Tokyo (JP); Yasuhiro MIZUKOSHI, Tokyo (JP); Kouki OOURA, Tokyo (JP)

(73) Assignee: NEC Corporation, Tokyo (JP)

(21) Appl. No.: 19/166,113

(22) PCT Filed: Mar. 27, 2023
(86) PCT No.: PCT/JP2023/012187

§ 371 Date: Sep. 17, 2025

(51) Int. Cl. G01C 21/34; B65G 67/04; B65G 67/24

(52) U.S. Cl. CPC G01C 21/3469; B65G 67/04; B65G 67/24

(57) ABSTRACT

An information processing device (10) comprises an acquisition unit (110) and a calculation unit (120). The acquisition unit (110) acquires route information and load information. The route information indicates a delivery route including one or more points where an electric vehicle (20) for delivering a cargo will stop. In addition, the load information includes information relating to the cargo to be loaded onto the electric vehicle (20) or to be unloaded from the electric vehicle (20) at each point. The calculation unit (120) uses the route information and the load information to calculate the expected power consumption amount for when the electric vehicle (20) travels in accordance with the delivery route.

### TECHNICAL FIELD

The present invention relates to an information processing device, an information processing method, and a non-transitory computer-readable recording medium.

### BACKGROUND ART

An example of a technique for estimating an energy consumption amount in a case where a vehicle moves to a certain destination is disclosed in, for example, PTL 1 below. PTL 1 discloses a technique for estimating consumed energy during traveling of a vehicle, the technique including the following steps (1) to (3).
(1) Acquiring route identification information for identifying a route to a destination
(2) Reading, from a predetermined storage unit, information indicating position dependency of a traveling speed of a vehicle on a route indicated by the route identification information (per-route speed information)
(3) Calculating an estimated value of the carbon dioxide emission amount or the consumed energy in a case where the vehicle travels along the route indicated by the route identification information using the read per-route speed information

### CITATION LIST

### Patent Literature

PTL 1: JP 2012-202773 A

### SUMMARY OF INVENTION

### Technical Problem

In the technique of PTL 1 described above, the amount of consumed energy in a case where a vehicle travels along a certain route is calculated in consideration of the “traveling speed of the vehicle”. However, the factor that determines the amount of energy consumed when the vehicle travels may be other than the “traveling speed of the vehicle”. In this respect, it can be said that the technique of PTL 1 has room for improvement in the accuracy of estimating the amount of energy consumed in a case where the vehicle moves to a certain destination.

In view of the above-described problems, an object of the present invention is to provide an information processing device, an information processing method, and a non-transitory computer-readable recording medium for improving accuracy of estimating an amount of energy consumed in a case where a vehicle moves to a destination.

### Solution to Problem

According to an aspect of the present invention, provided is an information processing device including an acquisition means for acquiring route information indicating a delivery route including one or more points where an electric vehicle that delivers a load stops by and load information related to a load loaded on the electric vehicle or unloaded from the electric vehicle at each of the points, and a calculation means for calculating a predicted power consumption amount in a case where the electric vehicle travels along the delivery route using the route information and the load information.

According to an aspect of the present invention, provided is an information processing method executed by at least one computer, the method including acquiring route information indicating a delivery route including one or more points where an electric vehicle that delivers a load stops by and load information related to a load loaded on the electric vehicle or unloaded from the electric vehicle at each of the points, and calculating a predicted power consumption amount in a case where the electric vehicle travels along the delivery route using the route information and the load information.

According to an aspect of the present invention, provided is a non-transitory computer-readable recording medium that records a program for causing at least one computer to function as an acquisition means for acquiring route information indicating a delivery route including one or more points where an electric vehicle that delivers a load stops by and load information related to a load loaded on the electric vehicle or unloaded from the electric vehicle at each of the points, and a calculation means for calculating a predicted power consumption amount in a case where the electric vehicle travels along the delivery route using the route information and the load information.

### Advantageous Effects of Invention

According to an aspect of the present invention, estimation accuracy of an amount of energy consumed when a vehicle moves to a destination is improved.

### BRIEF DESCRIPTION OF DRAWINGS

FIG. 1 It is a diagram illustrating an outline of an information processing device according to the first example embodiment.

FIG. 2 It is a diagram illustrating a hardware configuration of a computer that implements the information processing device according to the present disclosure.

FIG. 3 It is a flowchart illustrating an outline of an operation of the information processing device according to the first example embodiment.

FIG. 4 It is a flowchart illustrating a flow of processing executed by an information processing device according to the second example embodiment.

FIG. 5 It is a diagram illustrating an example of load information.

FIG. 6 It is a flowchart illustrating a flow of processing executed by an information processing device according to a modification of the second example embodiment.

FIG. 7 It is a diagram illustrating a functional configuration of an information processing device according to the third example embodiment.

FIG. 8 It is a flowchart illustrating a flow of processing executed by the information processing device according to the third example embodiment.

### EXAMPLE EMBODIMENT

Hereinafter, example embodiments of the present invention will be described with reference to the drawings. In all the drawings, the same components are denoted by the same reference numerals, and the description thereof will be omitted as appropriate. Unless otherwise described, in each block diagram, each block represents not a configuration of a hardware unit but a configuration of a functional unit. In a case where elements such as blocks in the figure are linked by arrows, the directions of the arrows are merely intended to facilitate understanding of the flow of information. In this case, the direction of the arrow does not limit the direction of communication (one-way communication/two-way communication) unless otherwise specified.

In the following description, “acquisition” includes at least one of a host device going to obtain data or information stored in another device or a storage medium (active acquisition) and inputting data or information output from another device to the host device (passive acquisition). Examples of the active acquisition include requesting or inquiring another device and receiving a reply thereto, and accessing and reading another device or a storage medium. Examples of passive acquisition include reception of information to be distributed (Alternatively, transmission, push notification, and the like). Further, “acquisition” may be selecting and acquiring from among received data or information, or selecting and receiving distributed data or information.

### First Example Embodiment

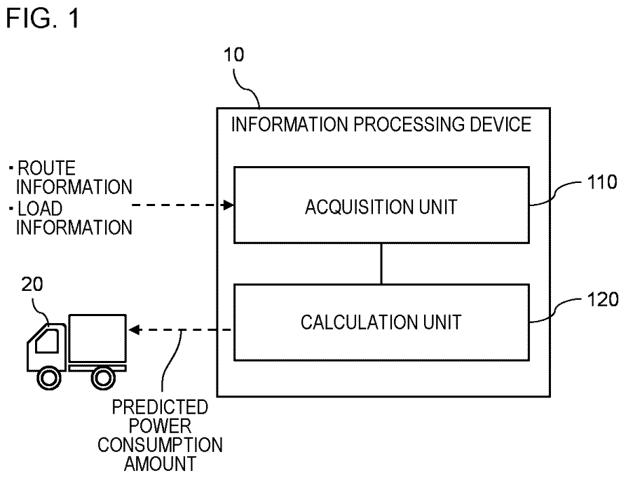

FIG. 1 is a diagram illustrating an outline of an information processing device 10 according to the first example embodiment. In the drawing, the information processing device 10 includes an acquisition unit 110 and a calculation unit 120.

The acquisition unit 110 acquires information about a vehicle 20 (hereinafter, also referred to as an “electric vehicle 20”) that covers part or all of a power source with electric power, such as an electric vehicle (EV) and a plug-in hybrid electric vehicle (PHEV). The electric vehicle 20 is used to deliver the load. The information acquired by the acquisition unit 110 includes route information and load information about the electric vehicle 20. The route information includes information indicating a delivery route including one or more points where the electric vehicle 20 stops by. The load information includes information about the load to be loaded onto the electric vehicle 20 or the load to be unloaded from the electric vehicle 20 at each point.

Based on the route information and the load information acquired by the acquisition unit 110, the calculation unit 120 calculates the power consumption amount (hereinafter, also referred to as a “predicted power consumption amount”) in a case where the electric vehicle 20 travels along the delivery route indicated by the route information. The calculation unit 120 can provide information about the calculated predicted power consumption amount to, for example, the electric vehicle 20.

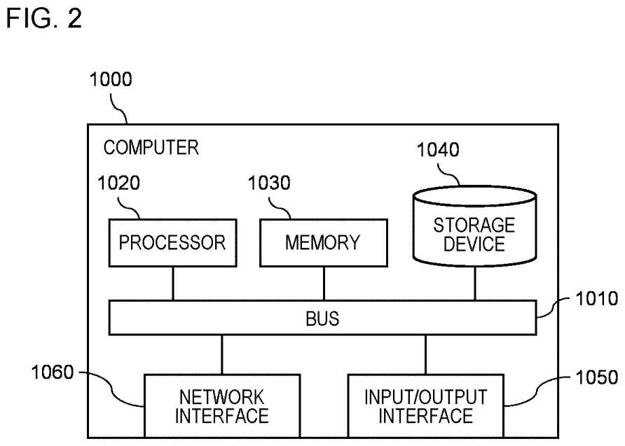

FIG. 2 is a diagram illustrating a hardware configuration of a computer 1000 that implements the information processing device 10 according to the present disclosure.

The computer 1000 includes a bus 1010, a processor 1020, a memory 1030, a storage device 1040, an input/output interface 1050, and a network interface 1060.

The bus 1010 is a data transmission path for the processor 1020, the memory 1030, the storage device 1040, the input/output interface 1050, and the network interface 1060 to transmit and receive data to and from each other. However, the method of connecting the processor 1020 and the like to each other is not limited to the bus connection.

The processor 1020 is a central processing unit (CPU), a graphics processing unit (GPU), or the like.

The memory 1030 is a main storage device achieved by a random access memory (RAM) or the like.

The storage device 1040 is an auxiliary storage device achieved by a hard disk drive (HDD), a solid state drive (SSD), a memory card, a read only memory (ROM), or the like. The storage device 1040 stores at least a program module related to the function of the acquisition unit 110 and a program module related to the function of the calculation unit 120.

The processor 1020 implements a function related to the program module by developing the program module read from the storage device 1040 on the memory 1030 and executing the program module. For example, the processor 1020 implements the function of the acquisition unit 110 described in the present disclosure by reading and executing a program module related to the acquisition unit 110 on the memory 1030. Similarly, the processor 1020 implements the function of the calculation unit 120 described in the present disclosure by reading a program module related to the calculation unit 120 on the memory 1030 and executing the program module. The operation of the processor 1020 is common to the example embodiments included in the present disclosure.

The program module described above may be recorded in a recording medium other than the storage device 1040. The recording medium that records the program module includes any medium that can be used by the non-transitory tangible computer 1000. A program code that can be read by the computer 1000 (processor 1020) may be embedded in the recording medium in which the program module is recorded.

The input/output interface 1050 is an interface that connects the computer 1000 and various input/output devices.

The network interface 1060 is an interface that connects the computer 1000 to a network. The network includes, for example, a Local Area Network (LAN), a Wide Area Network (WAN), a Controller Area Network (CAN) of the electric vehicle 20, and the like. The network interface 1060 connects the computer 1000 (information processing device 10) to various networks by wireless or wired connection.

The computer 1000 can be connected to a necessary device via the input/output interface 1050 or the network interface 1060. The “necessary device” mentioned here is not particularly limited, but is, for example, an input device such as an operation button, a keyboard, a touch panel, or a mouse, and an output device such as a display, a camera, a speaker, a microphone, or a printer.

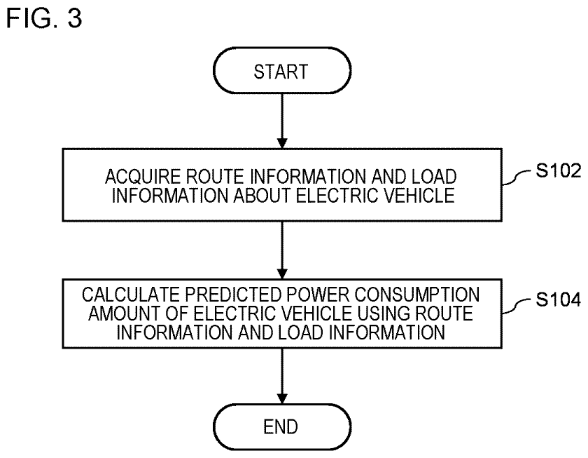

FIG. 3 is a flowchart illustrating an outline of the operation of the information processing device 10 according to the first example embodiment.

First, the acquisition unit 110 acquires route information and load information about the electric vehicle 20 (S102). The acquisition unit 110 can generate route information about the electric vehicle 20 by acquiring data of a departure place and a destination. Alternatively, the acquisition unit 110 can acquire the route information by inputting the acquired data of the departure place and the destination to another navigation system (not illustrated). The acquisition unit 110 communicates with a mobile terminal (not illustrated) possessed by a person who drives the electric vehicle 20 or a server device (not illustrated) of a delivery company that manages the electric vehicle 20, thereby acquiring load information associated with the electric vehicle 20. The calculation unit 120 calculates the predicted power consumption amount of the electric vehicle 20 using the route information and the load information acquired by the acquisition unit 110 (S104).

As described above, the information processing device 10 of the present example embodiment calculates the power consumption amount in a case where the electric vehicle 20 travels along a certain route further using the information related to the load loaded on the electric vehicle 20, that is, the “load information”. As will be described in detail later, it can be said that the load information provides information about further factors that may affect the amount of energy consumed by the electric vehicle 20, such as the predicted amount of use of the electric facility provided in the electric vehicle 20 and the total weight of the electric vehicle 20. That is, according to the present example embodiment, an information processing device, an information processing method, and a non-transitory computer-readable recording medium for improving estimation accuracy of an amount of energy consumed in a case where a vehicle moves to a destination are provided.

Hereinafter, in another example embodiment, a detailed example of the information processing device 10 will be described.

### Second Example Embodiment

The present example embodiment is similar to the first example embodiment except for the points described below.

The information processing device 10 according to the present example embodiment has a functional configuration (for example, FIG. 1) similar to that of the information processing device 10 described in the first example embodiment. The calculation unit 120 of the present example embodiment calculates the number of times the electric vehicle 20 uses the electric facility at each point based on the load information acquired by the acquisition unit 110. The “electric facility” is not particularly limited, but is, for example, a lift, a crane, or the like used when a load is loaded into or unloaded from a container of the electric vehicle 20. The calculation unit 120 calculates the amount of power consumed at the time of loading and unloading the load (hereinafter, also referred to as a “first power consumption amount”) based on the calculated number of times of use of the electric facility. Hereinafter, the flow of processing in the present example embodiment will be described with specific examples.

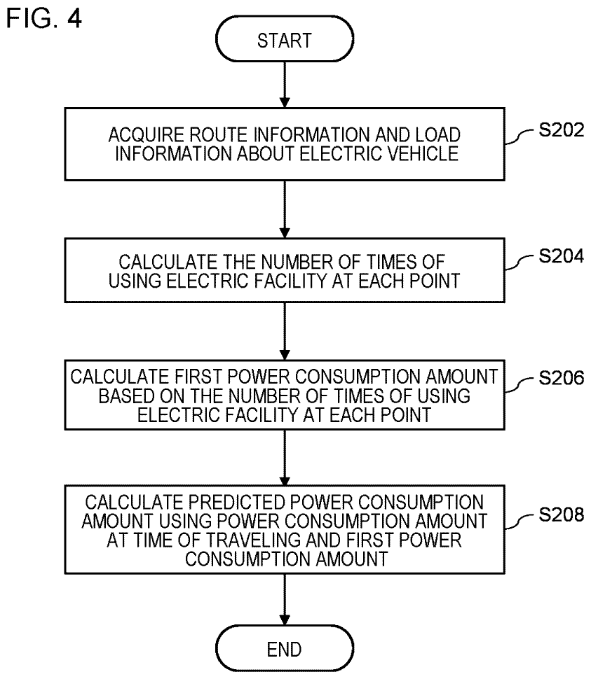

FIG. 4 is a flowchart illustrating a flow of processing executed by the information processing device 10 according to the second example embodiment.

First, the acquisition unit 110 acquires route information and load information about the electric vehicle 20 (S202). This process is similar to S102 in FIG. 3.

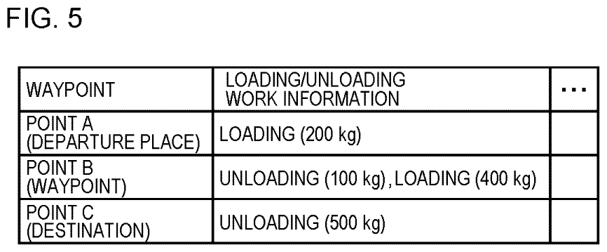

The calculation unit 120 calculates the number of times the electric vehicle 20 uses the electric facility at each point based on the load information acquired by the acquisition unit 110 (S204). Hereinafter, a specific operation of the calculation unit 120 will be described with reference to FIG. 5.

FIG. 5 is a diagram illustrating an example of load information. The load information illustrated in FIG. 5 includes information (loading/unloading work information) on loading/unloading work scheduled at each of a point A, a point B, and a point C. According to the load information illustrated in FIG. 5, the following information (1) to (3) regarding loading and unloading of load is obtained.
(1) Loading 200 kg of load at the point A
(2) unloading 100 kg of load and loading 400 kg of load at the point B
(3) unloading 500 kg of load at the point C

It is assumed that the electric vehicle 20 is provided with a lift having a load bearing capacity of 200 kg. In this case, information indicating that the load bearing capacity of the electric facility (lift) provided in the electric vehicle 20 is “200 kg” is stored in advance in a storage area (for example, the storage device 1040 or the like) accessible from the calculation unit 120. For example, the information processing device 10 can access a server (not illustrated) of a delivery company that manages the electric vehicle 20 in advance, acquire information about the electric facility provided in the electric vehicle 20, and store the information in a storage area such as the storage device 1040. The calculation unit 120 can calculate the number of times of use of the lift at the point A as “one time” using the information indicating that the load bearing capacity of the lift of the electric vehicle 20 is “200 kg”. The calculation unit 120 can similarly calculate the number of times of use of the lift at the point B as “three times”. The calculation unit 120 can similarly calculate the number of times of use of the lift at the point C as “three times”.

Returning to FIG. 4, the description will be continued. After calculating the number of times of use of the electric facility (lift) of the electric vehicle 20, the calculation unit 120 calculates the first power consumption amount based on the number of times of use of the electric facility (lift) (S206). The calculation unit 120 can acquire information indicating a power consumption amount of the electric facility (lift) per one time from information about the electric facility (lift) stored in advance in the storage device 1040. The calculation unit 120 can calculate the first power consumption amount by multiplying the power consumption amount per one time thus acquired by the calculated number of times of use of the electric facility (lift).

The calculation unit 120 calculates the predicted power consumption amount by adding the amount of power consumed by traveling on the delivery route indicated by the route information and the amount of power consumed by the electric facility (first power consumption amount) calculated in S206 (S208). The calculation unit 120 can calculate the amount of power consumed by traveling on the delivery route, for example, using the moving distance of the delivery route indicated by the route information and the information about the power consumption amount per unit distance regarding the electric vehicle 20. As a specific example, it is assumed that the total moving distance of the delivery route is “1000 km” and the power consumption amount of the electric vehicle 20 per unit distance (for example, 1 km) is “150 Wh (Watt-hour)”. In this case, the calculation unit 120 can calculate the amount of power consumed by traveling on the delivery route as “150 kWh”. The calculation unit 120 may use another parameter when calculating the amount of power consumed by traveling on the delivery route. For example, the power consumption amount may be predicted in consideration of an acceleration resistance value, an air resistance value, a gradient resistance value, a rolling resistance value, and the like regarding the electric vehicle 20. In addition, the calculation unit 120 may use the additional information described in another example embodiment when calculating the amount of power consumed by traveling on the delivery route.

As described above, according to the present example embodiment, first, the number of times of use of the electric facility (lift or the like) of the electric vehicle 20 is calculated at each point in the delivery route based on the load information about the electric vehicle 20. The amount of power consumed at the time of loading and unloading the load (first power consumption amount) is calculated based on the number of times of use. As described above, in the present example embodiment, the power consumption amount other than the power consumed at the time of traveling on the delivery route, specifically, the amount of power consumed by the electric facility at the time of loading and unloading the load (first power consumption amount) is calculated. With such a configuration, the amount of power consumed in a case where the electric vehicle 20 that delivers the load moves along a certain delivery route is estimated with higher accuracy.

### Modification of Second Example Embodiment

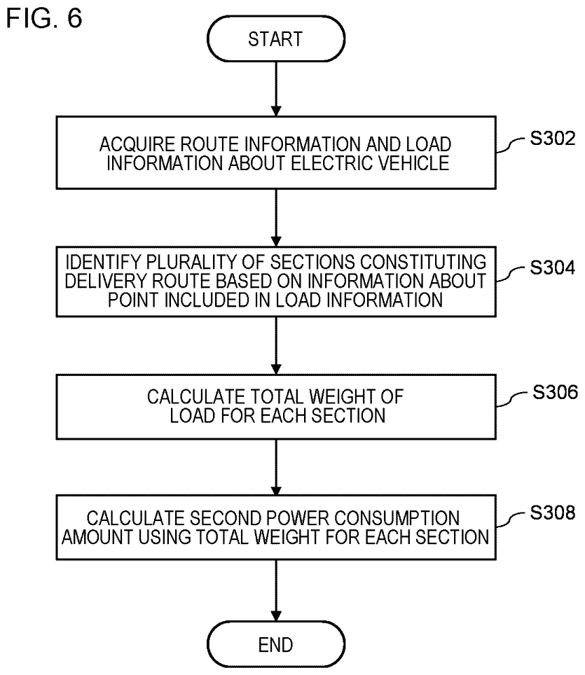

Instead of or in addition to the second example embodiment described above, the calculation unit 120 may operate as described below. FIG. 6 is a flowchart illustrating a flow of processing executed by the information processing device 10 according to a modification of the second example embodiment.

First, the acquisition unit 110 acquires route information and load information about the electric vehicle 20 (S302). This process is similar to S102 in FIG. 3 and S202 in FIG. 4.

The calculation unit 120 of the present modification identifies a plurality of sections constituting the delivery route based on the information about the point of the load information (S304). For example, it is assumed that the acquisition unit 110 acquires the load information illustrated in FIG. 5. In this case, the calculation unit 120 identifies that the delivery route is constituted by a first section from the point A (departure place) to the point B (waypoint) and a second section from the point B (waypoint) to the point C (destination) based on the acquired load information. The calculation unit 120 calculates the total weight of the load for each section divided by points in this manner. For example, the calculation unit 120 can calculate the total weight of the load in the first section as “200 kg” based on the load information illustrated in FIG. 5. Similarly, the calculation unit 120 can calculate the total weight of the load in the second section as “500 kg” based on the load information illustrated in FIG. 5.

The calculation unit 120 calculates the amount of power consumed in a case where the electric vehicle 20 travels on the delivery route (hereinafter, also referred to as a “second power consumption amount”) using the route information acquired by the acquisition unit 110 and the total weight of the load calculated for each section (S306). For example, the calculation unit 120 can calculate the second power consumption amount as follows. First, the calculation unit 120 identifies the moving distance for each section based on the route information. The calculation unit 120 calculates the power consumption amount for each section by multiplying the power consumption amount estimated from the moving distance for each section by a coefficient related to the total weight of the load for each section. The “coefficient” is predefined using a table, a function, or the like in such a way as to increase in proportion to the total weight of the load. That is, in a case where the calculation unit 120 uses the load information illustrated in FIG. 5, the first coefficient related to the total weight “200 kg” of the load in the first section is smaller than the second coefficient related to the total weight “500 kg” of the load in the second section. The calculation unit 120 calculates the second power consumption amount by adding the power consumption amount of each section.

As described above, in the present modification, first, the total weight of the load in each section of the delivery route is calculated based on the load information about the electric vehicle 20. The power consumption amount (second power consumption amount) consumed by the electric vehicle 20 traveling on the delivery route indicated by the route information is calculated using the total weight for each section. As described above, in the case of calculating the amount of power consumed at the time of traveling on the delivery route, a change in the weight of the vehicle body due to the load to be loaded is considered in the present modification. As a result, the power consumption amount in a case where the electric vehicle 20 moves along a certain delivery route can be estimated with higher accuracy.

By combining the configuration of the above-described second example embodiment and the configuration of the present modification, it is possible to further improve the estimation accuracy of the power consumption amount in a case where the electric vehicle 20 moves along a certain delivery route.

The information processing device 10 may be configured to output information based on the predicted power consumption amount to the user (for example, a person who drives the electric vehicle 20). For example, the information processing device 10 may display a screen including a predicted power consumption amount in a case where the electric vehicle 20 moves along a certain delivery route on a navigation device provided in the electric vehicle 20 or a terminal used by the user. The information processing device 10 may be configured to acquire the remaining battery level of the electric vehicle 20 via the CAN of the electric vehicle 20 or the like, and display information indicating a difference between the remaining battery level and the predicted power consumption amount. The information output in the latter case includes, for example, information indicating a predicted value of the remaining battery level after traveling the delivery route, and information indicating whether the delivery route can be traveled with the current remaining battery level. Such information helps a person who drives the electric vehicle 20 to appropriately make a travel plan of the delivery route.

### Third Example Embodiment

The present example embodiment is similar to any of the first example embodiment and the second example embodiment except for the points described below.

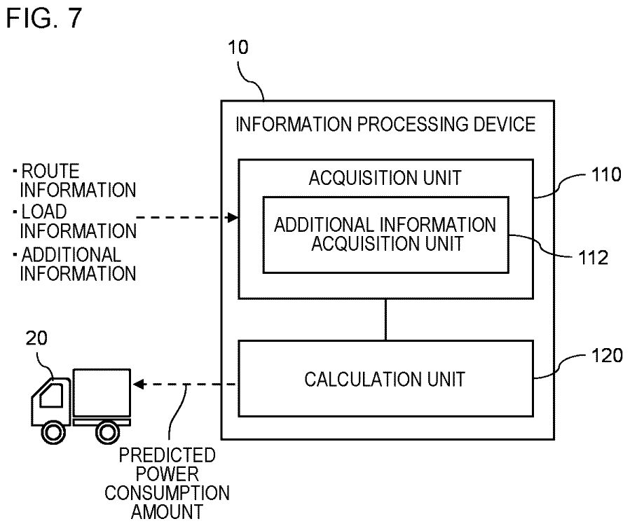

FIG. 7 is a diagram illustrating a functional configuration of the information processing device 10 according to the third example embodiment. In the information processing device 10 illustrated in FIG. 7, the acquisition unit 110 further includes an additional information acquisition unit 112. The additional information acquisition unit 112 acquires additional information used when calculating the predicted power consumption amount in a case where the electric vehicle 20 moves according to the delivery route indicated by the route information.

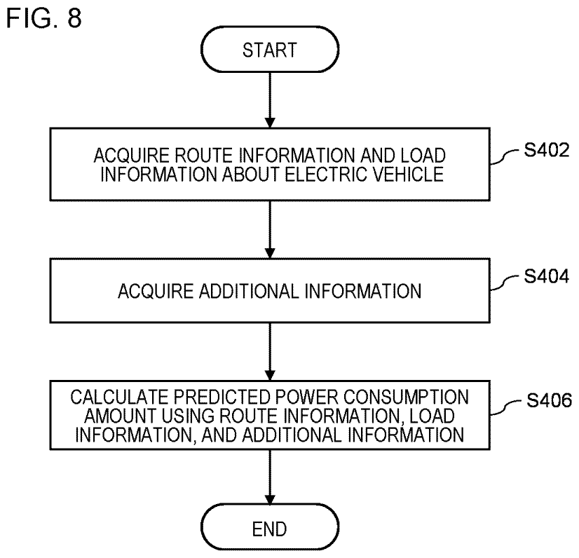

FIG. 8 is a flowchart illustrating a flow of processing executed by the information processing device 10 according to the third example embodiment.

First, the acquisition unit 110 acquires route information and load information about the electric vehicle 20 (S402). This processing is similar to S102 in FIG. 3, S202 in FIG. 4, and S302 in FIG. 6. In the present example embodiment, in addition to the route information and the load information, the additional information acquisition unit 112 of the acquisition unit 110 acquires additional information (S404). The calculation unit 120 performs processing using additional information as described below in addition to the processing described in the first example embodiment and the second example embodiment, and calculates a power consumption amount (second power consumption amount) consumed by the electric vehicle 20 traveling on the delivery route indicated by the route information (S406). Hereinafter, some specific examples of the operation of the information processing device 10 of the present example embodiment will be described.

As an example, the additional information acquisition unit 112 further acquires individual information about the electric vehicle 20 as additional information. The individual information about the electric vehicle 20 is, for example, a vehicle type, a vehicle name, and the like of the electric vehicle 20. The type of the individual information about the electric vehicle 20 is not limited as long as it is information from which specifications (for example, a travelable distance per unit distance, and the like) of the electric vehicle 20 can be grasped. The calculation unit 120 calculates the power consumption amount (second power consumption amount) consumed by the electric vehicle 20 traveling on the delivery route indicated by the route information, further using the specification information about the electric vehicle 20 obtained from the individual information about the electric vehicle 20. By doing so, it is possible to expect an effect of enhancing the estimation accuracy of the power consumption amount in a case where the electric vehicle 20 moves along a certain delivery route.

As another example, the additional information acquisition unit 112 further acquires attribute information indicating an attribute of the load as additional information. As the attribute of the load, any attribute that can affect the traveling of the electric vehicle 20 is included. Specific examples of the “attribute that can affect the traveling of the electric vehicle 20” include attributes such as “precision equipment” and “fragile”. Since the load having these attributes is required to be handled delicately, there is a high possibility that a person who controls the operation of the electric vehicle 20 operates the accelerator or the brake more slowly than usual. That is, it can be said that there is a high possibility that a person who drives the electric vehicle 20 operates the electric vehicle 20 in such a way as to suppress the power consumption amount.

Therefore, in a case where the additional information acquisition unit 112 acquires attribute information indicating an attribute of a specific load such as “precision equipment” or “fragile”, the calculation unit 120 executes calculation to reduce the second power consumption amount. Although not particularly limited, the calculation unit 120 operates as follows, for example. First, a predetermined coefficient (a real number of 0 or more and less than 1) is defined in a program module of the calculation unit 120 in association with an attribute of a load such as “precision equipment” or “fragile”. This coefficient can be obtained, for example, based on actual data when one or a plurality of electric vehicles 20 actually delivered a load related to a specific attribute. In a case where the attribute of the load associated with the coefficient defined in this way is acquired, the calculation unit 120 reads the coefficient. The calculation unit 120 can calculate the second power consumption amount with higher accuracy by multiplying the power consumption amount calculated based on the route information (the amount of power consumed in the traveling operation of the electric vehicle 20) by the coefficient.

As another example, the additional information acquisition unit 112 further acquires information (hereinafter, also referred to as an “atmospheric temperature information”) related to the atmospheric temperature at the time of traveling as additional information. The atmospheric temperature information may be, for example, information indicating a season, a date and time, or a time zone when the vehicle travels on the delivery route, or may be information indicating an estimated atmospheric temperature of a time zone when the vehicle travels on the delivery route provided from another system. An increase in power consumption of an air conditioner or the like of the electric vehicle 20 is predicted according to the atmospheric temperature. Therefore, the calculation unit 120 predicts the power consumption amount to be used by the air conditioner while the electric vehicle 20 is traveling based on the atmospheric temperature information, and adds the predicted power consumption amount to the second power consumption amount. The information indicating the relationship between the atmospheric temperature and the power consumption amount in the air conditioner can be created based on, for example, data collected when the electric vehicle 20 actually travels. By doing so, it is possible to expect an effect of enhancing the estimation accuracy of the power consumption amount in a case where the electric vehicle 20 moves along a certain delivery route.

As another example, the additional information acquisition unit 112 acquires traveling record information of the delivery route as additional information. In this example, it is assumed that information indicating a route on which an any electric vehicle 20 has actually traveled when delivering a load and data collected using various sensors or the like of the electric vehicle 20 during the traveling are associated with each other and accumulated in a database (not illustrated) in advance. In this case, based on the information accumulated in the database, information (for example, the average value or median value of the speed or acceleration) indicating at least one of the traveling speed and the acceleration is generated in units of routes or in units of sections constituting the routes. The information generated in this manner is stored in a database (not illustrated) in association with information for identifying a route or a section. The additional information acquisition unit 112 can acquire traveling record information about the related route or section from a database (not illustrated) based on the route information acquired in S402.

The calculation unit 120 calculates the second power consumption amount further using at least one of the traveling speed and the acceleration in units of routes or units of sections indicated by the acquired traveling record information. The calculation unit 120 can calculate the power consumption amount according to the actual traveling record based on the specification of the electric vehicle 20 and at least one of the traveling speed and the acceleration in units of routes or units of sections.

As another example, the additional information acquisition unit 112 acquires, as the additional information, information (hereinafter, also referred to as “road classification information”) indicating a classification of a road included in the delivery route indicated by the route information. The classification of the road is, for example, a street, a general road, a highway, a motor way, or the like. It can be said that the classification of the road affects the average traveling speed and acceleration of the electric vehicle 20, that is, the power consumption amount during traveling of the electric vehicle 20. Therefore, the calculation unit 120 calculates the second power consumption amount by multiplying the power consumption amount calculated for each classification by a coefficient related to the classification of the road included in the delivery route. By doing so, it is possible to expect an effect of enhancing the estimation accuracy of the power consumption amount in a case where the electric vehicle 20 moves along a certain delivery route.

The additional information acquisition unit 112 may acquire a plurality of types of specific additional information exemplified here. In this case, the calculation unit 120 performs processing based on the plurality of types of additional information acquired by the additional information acquisition unit 112, and calculates the second power consumption amount.

Although the example embodiments of the present invention have been described above with reference to the drawings, these are examples of the present invention, and various configurations other than the above can be used. For example, when calculating the second power consumption amount in the third example embodiment, a model constructed by machine learning may be used. The training data used for machine learning of the model can be created based on actual travel data. For example, it is possible to generate training data in which information indicating individual information about the electric vehicle 20, attribute information of a load, the atmospheric temperature information at the time of traveling, a change in speed or acceleration during traveling, and a classification of a road on which the electric vehicle has traveled, and a power consumption amount are paired. By training the model using such training data, it is possible to construct a model for estimating the power consumption amount consumed when the electric vehicle 20 travels, using the individual information about the electric vehicle 20, the attribute information of the load, and the like as inputs.

In the plurality of flowcharts used in the above description, a plurality of steps (processes) is described in order, but the execution order of the steps executed in each example embodiment is not limited to the described order. In each example embodiment, the order of the illustrated steps can be changed as long as there is no problem in terms of content. The above-described example embodiments can be combined within a range in which the contents are not contradictory.

Some or all of the example embodiments described above may be described as the following Supplementary Notes, but are not limited to the following.

### Supplementary Note 1

An information processing device including
an acquisition means for acquiring route information indicating a delivery route including one or more points where an electric vehicle that delivers a load stops by and load information related to a load loaded on the electric vehicle or unloaded from the electric vehicle at each of the points, and
a calculation means for calculating a predicted power consumption amount in a case where the electric vehicle travels along the delivery route using the route information and the load information.

### Supplementary Note 2

The information processing device according to Supplementary Note 1, wherein the calculation means
calculates the number of times of use of a lift of the electric vehicle at each point based on the load information, and
calculates a first power consumption amount consumed at a time of loading and unloading the load based on the number of times of use of the lift.

### Supplementary Note 3

The information processing device according to Supplementary Note 1 or 2, wherein the calculation means
calculates a total weight of the load for each section of the delivery route divided by the points based on the load information, and
calculates a second power consumption amount consumed at a time of traveling on the delivery route using the route information and the total weight for each section.

### Supplementary Note 4

The information processing device according to Supplementary Note 2 or 3, wherein
the acquisition means further acquires individual information about the electric vehicle, and
the calculation means calculates a second power consumption amount consumed at a time of traveling on the delivery route further using the individual information.

### Supplementary Note 5

The information processing device according to any one of Supplementary Notes 2 to 4, wherein
the acquisition means further acquires attribute information indicating an attribute of the load, and
the calculation means calculates a second power consumption amount consumed at a time of traveling on the delivery route further using the attribute information.

### Supplementary Note 6

The information processing device according to any one of Supplementary Notes 2 to 5, wherein
the acquisition means further acquires atmospheric temperature information related to an atmospheric temperature at a time of traveling, and
the calculation means calculates a second power consumption amount consumed at a time of traveling on the delivery route further using the atmospheric temperature information.

### Supplementary Note 7

The information processing device according to any one of Supplementary Notes 2 to 6, wherein
the acquisition means further acquires traveling record information accumulated for the delivery route, and
the calculation means calculates a second power consumption amount consumed at the time of traveling on the delivery route further using the traveling record information.

### Supplementary Note 8

The information processing device according to any one of Supplementary Notes 2 to 7, wherein
the acquisition means further acquires road classification information indicating a classification of a road included in the delivery route, and
the calculation means calculates a second power consumption amount consumed at a time of traveling on the delivery route further using the road classification information.

### Supplementary Note 9

An information processing method executed by at least one computer, the method including
acquiring route information indicating a delivery route including one or more points where an electric vehicle that delivers a load stops by and load information related to a load loaded on the electric vehicle or unloaded from the electric vehicle at each of the points, and
calculating a predicted power consumption amount in a case where the electric vehicle travels along the delivery route using the route information and the load information.

### Supplementary Note 10

The information processing method according to Supplementary Note 9, wherein the at least one computer
calculates the number of times of use of a lift of the electric vehicle at each point based on the load information, and
calculates a first power consumption amount consumed at a time of loading and unloading the load based on the number of times of use of the lift.

### Supplementary Note 11

The information processing method according to Supplementary Note 9 or 10, wherein the at least one computer
calculates a total weight of the load for each section of the delivery route divided by the points based on the load information, and
calculates a second power consumption amount consumed at a time of traveling on the delivery route using the route information and the total weight for each section.

### Supplementary Note 12

The information processing method according to Supplementary Note 10 or 11, wherein the at least one computer
further acquires individual information about the electric vehicle, and
calculates a second power consumption amount consumed at a time of traveling on the delivery route further using the individual information.

### Supplementary Note 13

The information processing method according to any one of Supplementary Notes 10 to 12, wherein the at least one computer
further acquires attribute information indicating an attribute of the load, and
calculates a second power consumption amount consumed at the time of traveling on the delivery route further using the attribute information.

### Supplementary Note 14

The information processing method according to any one of Supplementary Notes 10 to 13, wherein the at least one computer
further acquires atmospheric temperature information related to an atmospheric temperature at a time of traveling, and
calculates a second power consumption amount consumed at a time of traveling on the delivery route further using the atmospheric temperature information.

### Supplementary Note 15

The information processing method according to any one of Supplementary Notes 10 to 14, wherein the at least one computer
further acquires traveling record information accumulated for the delivery route, and
calculates a second power consumption amount consumed at a time of traveling on the delivery route further using the traveling record information.

### Supplementary Note 16

The information processing method according to any one of Supplementary Notes 10 to 15, wherein the at least one computer
further acquires road classification information indicating a classification of a road included in the delivery route, and
calculates a second power consumption amount consumed at a time of traveling on the delivery route further using the road classification information.

### Supplementary Note 17

A non-transitory computer-readable recording medium that records a program for causing at least one computer to function as
an acquisition means for acquiring route information indicating a delivery route including one or more points where an electric vehicle that delivers a load stops by and load information related to a load loaded on the electric vehicle or unloaded from the electric vehicle at each of the points, and
a calculation means for calculating a predicted power consumption amount in a case where the electric vehicle travels along the delivery route using the route information and the load information.

### Supplementary Note 18

The non-transitory computer-readable recording medium according to Supplementary Note 17, wherein the calculation means
calculates the number of times of use of a lift of the electric vehicle at each point based on the load information, and
calculates a first power consumption amount consumed at a time of loading and unloading the load based on the number of times of use of the lift.

### Supplementary Note 19

The non-transitory computer-readable recording medium according to Supplementary Note 17 or 18, wherein the calculation means
calculates a total weight of the load for each section of the delivery route divided by the points based on the load information, and
calculates a second power consumption amount consumed at a time of traveling on the delivery route using the route information and the total weight for each section.

### Supplementary Note 20

The non-transitory computer-readable recording medium according to Supplementary Note 18 or 19, wherein
the acquisition means further acquires individual information about the electric vehicle, and
the calculation means calculates a second power consumption amount consumed at a time of traveling on the delivery route further using the individual information.

### Supplementary Note 21

The non-transitory computer-readable recording medium according to any one of Supplementary Notes 18 to 20, wherein
the acquisition means further acquires attribute information indicating an attribute of the load, and
the calculation means calculates a second power consumption amount consumed at a time of traveling on the delivery route further using the attribute information.

### Supplementary Note 22

The non-transitory computer-readable recording medium according to any one of Supplementary Notes 18 to 21, wherein
the acquisition means further acquires atmospheric temperature information related to an atmospheric temperature at a time of traveling, and
the calculation means calculates a second power consumption amount consumed at a time of traveling on the delivery route further using the atmospheric temperature information.

### Supplementary Note 23

The non-transitory computer-readable recording medium according to any one of Supplementary Notes 18 to 22, wherein
the acquisition means further acquires traveling record information accumulated for the delivery route, and
the calculation means calculates a second power consumption amount consumed at a time of traveling on the delivery route further using the traveling record information.

### Supplementary Note 24

The non-transitory computer-readable recording medium according to any one of Supplementary Notes 18 to 23, wherein
the acquisition means further acquires road classification information indicating a classification of a road included in the delivery route, and
the calculation means calculates a second power consumption amount consumed at a time of traveling on the delivery route further using the road classification information.

### REFERENCE SIGNS LIST

10 information processing device
1000 computer
1010 bus
1020 processor
1030 memory
1040 storage device
1050 input/output interface
1060 network interface
110 acquisition unit
112 additional information acquisition unit
120 calculation unit
20 electric vehicle

What is claimed is:

1. An information processing apparatus comprising:
at least one memory storing instructions; and
at least one processor configured to execute the instructions to perform operations comprising:
acquiring route information indicating a delivery route including one or more points where an electric vehicle that delivers a load stops by and load information related to a load loaded on the electric vehicle or unloaded from the electric vehicle at each of the points; and
calculating a predicted power consumption amount in a case where the electric vehicle travels along the delivery route using the route information and the load information.

2. The information processing apparatus according to claim 1, wherein calculating the predicted power consumption amount comprises
calculating the number of times of use of a lift of the electric vehicle at each point based on the load information, and
calculating a first power consumption amount consumed at a time of loading and unloading the load based on the number of times of use of the lift.

3. The information processing apparatus according to claim 1, wherein calculating the predicted power consumption amount comprises
calculating a total weight of the load for each section of the delivery route divided by the points based on the load information, and
calculating a second power consumption amount consumed at a time of traveling on the delivery route using the route information and the total weight for each section.

4. The information processing apparatus according to claim 2, wherein
acquiring the route information comprises further acquiring individual information about the electric vehicle, and
calculating the predicted power consumption amount comprises calculating a second power consumption amount consumed at a time of traveling on the delivery route further using the individual information.

5. The information processing apparatus according to claim 2, wherein
acquiring the route information comprises further acquiring attribute information indicating an attribute of the load, and
calculating the predicted power consumption amount comprises calculating a second power consumption amount consumed at a time of traveling on the delivery route further using the attribute information.

6. The information processing apparatus according to claim 2, wherein
acquiring the route information comprises further acquiring atmospheric temperature information related to an atmospheric temperature at a time of traveling, and
calculating the predicted power consumption amount comprises calculating a second power consumption amount consumed at a time of traveling on the delivery route further using the atmospheric temperature information.

7. The information processing apparatus according to claim 2, wherein
acquiring the route information comprises further acquiring traveling record information accumulated for the delivery route, and
calculating the predicted power consumption amount comprises calculating a second power consumption amount consumed at a time of traveling on the delivery route further using the traveling record information.

8. The information processing apparatus according to claim 2, wherein
acquiring the route information comprises further acquiring road classification information indicating a classification of a road included in the delivery route, and
calculating the predicted power consumption amount comprises calculating a second power consumption amount consumed at a time of traveling on the delivery route further using the road classification information.

9. An information processing method executed by at least one computer, the method comprising:
acquiring route information indicating a delivery route including one or more points where an electric vehicle that delivers a load stops by and load information related to a load loaded on the electric vehicle or unloaded from the electric vehicle at each of the points; and
calculating a predicted power consumption amount in a case where the electric vehicle travels along the delivery route using the route information and the load information.

10. A non-transitory computer-readable medium that records a program for causing at least one computer to perform operations comprising:
acquiring route information indicating a delivery route including one or more points where an electric vehicle that delivers a load stops by and load information related to a load loaded on the electric vehicle or unloaded from the electric vehicle at each of the points; and
calculating a predicted power consumption amount in a case where the electric vehicle travels along the delivery route using the route information and the load information.

11. The information processing method according to claim 9, further comprising
calculating the number of times of use of a lift of the electric vehicle at each point based on the load information, and
calculating a first power consumption amount consumed at a time of loading and unloading the load based on the number of times of use of the lift.

12. The information processing method according to claim 9, further comprising
calculating a total weight of the load for each section of the delivery route divided by the points based on the load information, and
calculating a second power consumption amount consumed at a time of traveling on the delivery route using the route information and the total weight for each section.

13. The information processing method according to claim 11, further comprising
acquiring individual information about the electric vehicle, and
calculating a second power consumption amount consumed at a time of traveling on the delivery route further using the individual information.

14. The information processing method according to claim 11, further comprising
acquiring attribute information indicating an attribute of the load, and
calculating a second power consumption amount consumed at a time of traveling on the delivery route further using the attribute information.

15. The information processing method according to claim 11, further comprising
acquiring atmospheric temperature information related to an atmospheric temperature at a time of traveling, and
calculating a second power consumption amount consumed at a time of traveling on the delivery route further using the atmospheric temperature information.

16. The information processing method according to claim 11, further comprising
acquiring traveling record information accumulated for the delivery route, and
calculating a second power consumption amount consumed at a time of traveling on the delivery route further using the traveling record information.

17. The information processing method according to claim 11, further comprising
acquiring road classification information indicating a classification of a road included in the delivery route, and
calculating a second power consumption amount consumed at a time of traveling on the delivery route further using the road classification information.
